(19) United States
(12) Patent Application Publication
(10) Pub. No.: US 2005/0144415 A1
(43) Pub. Date: Jun. 30, 2005

(54) Resource management apparatus, systems, and methods

(75) Inventors: Sachin Doshi, Bangalore (IN); Himanshu Goel, Bangalore (IN)

Correspondence Address: SCHWEGMAN, LUNDBERG, WOESSNER & KLUTH, P.A., P.O. BOX 2938, MINNEAPOLIS, MN, 55402-0938, US

(73) Assignee: Intel Corporation

(21) Appl. No.: 10/750,933

(22) Filed: Dec. 30, 2003

(51) Int. Cl. G06F 13/00

(52) U.S. Cl. 711/173

(57) ABSTRACT

An apparatus and a system, as well as a method and article, may operate to allocate one or more links from a plurality of memory locations included in a memory segment of a memory to a port at substantially one time.

### TECHNICAL FIELD

Various embodiments described herein relate to data processing generally, including apparatus, systems, and methods used to share resources, such as memory.

A portion of this document contains material which is subject to copyright protection. The copyright owner has no objection to the facsimile reproduction by anyone of this document or other items including the protected material as maintained in the Patent and Trademark Office records, but otherwise reserves all rights whatsoever in this material. The following notice applies to the software and data as described below and in any drawings attached hereto: Copyright © 2003 Intel Corporation, All Rights Reserved.

### BACKGROUND INFORMATION

Data processing hardware, including switches, may provide a limited number of resources, such as memory, processor time, etc. that can be shared among a number of ports. Such resources may be shared in a fixed fashion or in a variable fashion. For example, a memory may be partitioned according to a fixed plan for sharing among a number of ports, such that each port is allocated a fixed amount of memory prior to any use of the ports (e.g., a hard partition). Alternatively, the memory may be partitioned on an as-needed, or use basis (e.g., soft partition), such that some portion of the memory is set aside as requested or needed by active ports. This second arrangement may utilize linked lists, wherein the shared memory is used to store information via linked pointers.

Due to the unpredictable nature of the network traffic, resources required by a selected group of ports may be non-uniform. Fixed partitions may result in under-utilization of resources for some ports, whereas for others the resource partition may be insufficient. A soft partition scheme may provide better allocation of resources, but extra hardware might be needed to manage a large number of linked lists. For example, if a linked list array has a 1:1 mapping ratio with the information array, then the linked list may be of the same depth as the depth of the information array, and each port may build an individual linked list using its own read/write pointers. Thus, apparatus, systems, and methods to more efficiently manage resource allocation are needed.

### BRIEF DESCRIPTION OF THE DRAWINGS

FIG. 1 is a block diagram of an apparatus and a system according to various embodiments;

FIG. 2 is a flow chart illustrating several methods according to various embodiments;

FIG. 3 is a pseudocode listing that illustrates several methods of supporting enqueue and dequeue operations according to various embodiments; and

FIG. 4 is a block diagram of an article according to various embodiments.

### DETAILED DESCRIPTION

A “resource,” for the purposes of this document, may include any virtual or physical item that can be shared among competing interests. For example, a resource may comprise processing time provided by a microprocessor, current provided by a power supply, queue storage provided by a memory, etc. Competing interests may include elements such as circuits, ports, programs, data sources, etc.

Many of the embodiments described herein provide resource management among competing interests that operate to balance resource usage. For example, several embodiments implement a first-in, first-out (FIFO) memory segment as a dynamic shared resource. Instead of having a 1:1 mapping ratio between an information array and a linked list array, the information array is partitioned in small segments (e.g., 4 locations of the information array may represent a segment). Each segment may represent a link. Thus, for example, all locations within the segment may operate as a FIFO having a depth of four.

When information for a selected port is to be enqueued, a free link may be allocated to that port, and the information may be written to the first location of the segment to which the free link points. To enqueue more information, the additional information may be written in successive locations of the partially used segment. To enqueue still further information, a new link may be allocated when all of the locations in the current segment are utilized.

To simplify the discussion of concepts surrounding various embodiments, a notation which relates various characteristics of the information (as well as the array used to hold the information, i.e., the “information array”) to the linked-list array is introduced as follows:
SLL=simple linked list having a 1:1 correspondence between the information array and the linked-list array
2-1LL=2 locations in the information array correspond to 1 location in the linked-list array
N-1LL=N locations in the information array correspond to 1 location in the linked-list array
LL_Type=1 (for SLL); 2 (for 2-1LL); 4 (for 4-1LL) . . . N (for N-₁LL). N may be a power of 2.
Total_Info_Bits=total number of information bits, and may be expressed as the width of the information times the depth of the information, or Info_Width*Info_Array_Depth
Total_Link_Bits=total number of link bits, and may be expressed as (Info_Array_Depth/LL_Type)*(Info_Array_Addr bits−log₂(LL_Type))
Worst_Wastage=computed as if a link is allocated to a partially active port, such that a single information location in that link is utilized, and the rest of the locations are not available to be shared with another port, and may be expressed as (Info_Width*LL_Type)+(Info_Width*Num_Ports*(LL_Type−1))
Sharable_Bits=Total_Info_Bits−Worst_Wastage
Information utilization=Sharable_Bits/Total_Info_Bits
Hardware utilization=Sharable_Bits/(Total_Info_Bits+Total_Link_Bits)

Various embodiments may be realized. For example, assuming 24 ports, an information width of 14 bits, and an information array depth of 2048 locations, the following results accrue: Info_Addr_Bits=12, and Total_Info_Bits=28672. TABLE I below states the results for different implementations of dynamic shared resource implementation by contrasting the prior art approach of using a SLL with some novel approaches involving linked-lists having multiply-corresponding information array locations, such as 2-1LL, 4-1LL, 8-1LL, 16-1LL and 32-1LL:

TABLE I

| | | Link | Link | Link | Total | Worst | Sharable | Info | Hardware |
|---|---|---|---|---|---|---|---|---|---|
| | LL_Type | Width | Depth | Bits | Bits | Wastage | Bits | Utilization | Utilization |
| SLL | 1 | 12 | 2048 | 24576 | 53248 | 14 | 28658 | 1.00 | 0.54 |
| 2-1LL | 2 | 11 | 1024 | 11264 | 39936 | 364 | 28308 | 0.99 | 0.71 |
| 4-1LL | 4 | 10 | 512 | 5120 | 33792 | 1064 | 27608 | 0.96 | 0.82 |
| 8-1LL | 8 | 9 | 256 | 2304 | 30976 | 2464 | 26208 | 0.91 | 0.85 |
| 16-1LL | 16 | 8 | 128 | 1024 | 29696 | 5264 | 23408 | 0.82 | 0.79 |
| 32-1LL | 32 | 7 | 64 | 448 | 29120 | 10864 | 17808 | 0.62 | 0.61 |

By maintaining information utilization loss to less than about 10%, the data in Table 1 show that maximum utilization can be achieved with an 8-1LL scheme, that is, 8 locations in the information array correspond to 1 location in the linked-list array. Depending on the input parameters (e.g., number of ports, information width, information depth), the quality of information and hardware utilization thus can be evaluated for different N-1LL linked-list schemes, and optimal solutions may be chosen.

In the prior art (i.e., using the SLL), a link was allocated for each and every piece of information to be enqueued. However, with the disclosed scheme of using linked-lists having multiple corresponding information array locations (e.g., 2-1LL, 4-1LL, . . . N-1LL), information can be efficiently segmented into information quanta (e.g., for a 4-1LL scheme, each quantum or chunk corresponds to a single link-list location and four information array locations), wherein each quantum may be represented by a single link. Whenever an information entry is to be enqueued, no second link need be allocated if a first link is already allocated to that port, and the corresponding segment has free space to accept enqueued information. The enqueued entry may simply be written into the available location, and the read/write pointer for the segment may be updated. Thus, for the purposes of this document, a “memory segment” may be defined as having at least two separately-addressable, multi-bit memory locations.

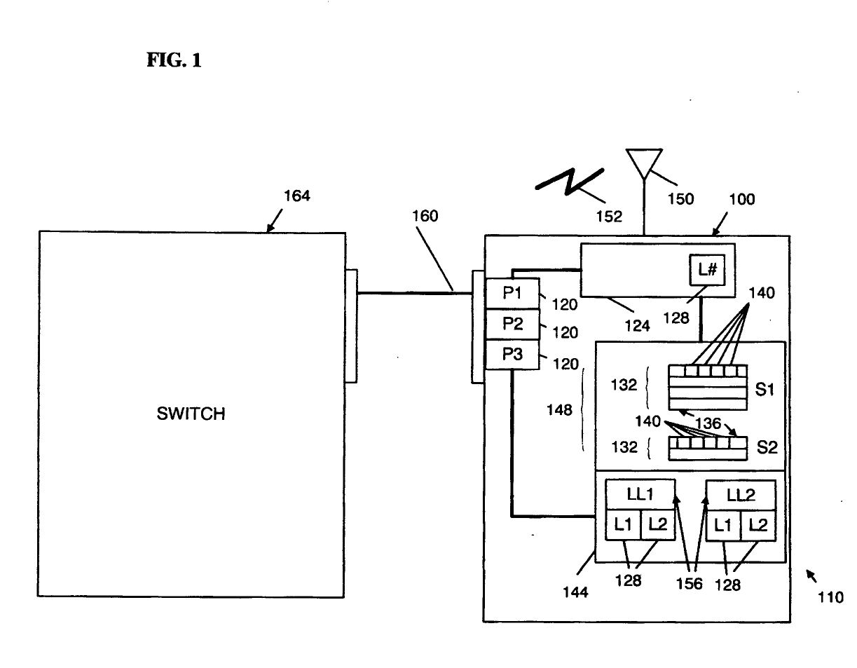

FIG. 1 is a block diagram of an apparatus 100 and a system 110 according to various embodiments, each of which may operate in the manner described above. For example, an apparatus 100 may comprise one or more ports 120 and a module 124 to allocate links 128 from a plurality of memory locations 132 included in a memory segment S1 to the ports 120, as desired. The allocation of a link 128 from a plurality of memory locations 132 to any one port (e.g., port P1) may occur substantially simultaneously, or at one time. Each of the memory locations 132 in a segment 136 may include a plurality of bits 140, including the same number of bits, or a different number of bits.

The memory 144, in turn, may comprise a plurality of memory segments 148, and each of the plurality of memory segments 148 may include the same number of memory locations 132, or a different number of memory locations 132.

In light of the ability to evaluate quality with respect to information and hardware utilization made possible by several embodiments, and demonstrated in exemplary fashion by TABLE I, the number of memory locations 132 included in each memory segment 136 may be chosen in accordance with a selected maximum hardware utilization. For example, the selected maximum hardware utilization may be substantially equal to a number of shareable bits divided by a sum of a total number of information bits and a total number of link bits. Similarly, the width of the information array may also be chosen. For example, the number of bits in the information array width may be selected to be about equal to or less than the value of log₂(the information array depth).

In another embodiment, a system 110 may comprise an apparatus 100 as described above, as well as a plurality of ports 120, a memory 144 coupled to the ports 120, and a module 124 to allocate links 128 to any number of ports 120. For example, the module 124 may operate to allocate a first link L1 from a plurality of memory locations 132 (e.g., included in a first memory segment S1 included in the memory 144) to a first port P1 at substantially a first time. The module 124 may also operate to allocate a second link L2 from a plurality of memory locations 132 (e.g., included in a second memory segment S2 included in the memory 144) to a second port P2 at substantially a second time.

The system 110 may include an antenna 150, such as a monopole, dipole, patch, or omnidirectional antenna to receive information 152 that can be stored in the memory 144, which may in turn be used to store one or more links 128, including one or more linked-lists 156 containing the links 128. The system 110 may also include a communications medium 160 to couple one or more of the ports 120 to a data switch 164.

The apparatus 100, system 110, ports 120, module 124, links 128, memory locations 132, segments 136, bits 140, memory 144, memory segments 148, antenna 150, information 152, linked-lists 156, communications medium 160, and data switch 164 may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100 and the system 110, and as appropriate for particular implementations of various embodiments.

It should also be understood that the apparatus and systems of various embodiments can be used in applications other than for communications ports, and other than for systems that include data switches, and thus, various embodiments are not to be so limited. The illustrations of an apparatus 100 and a system 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others.

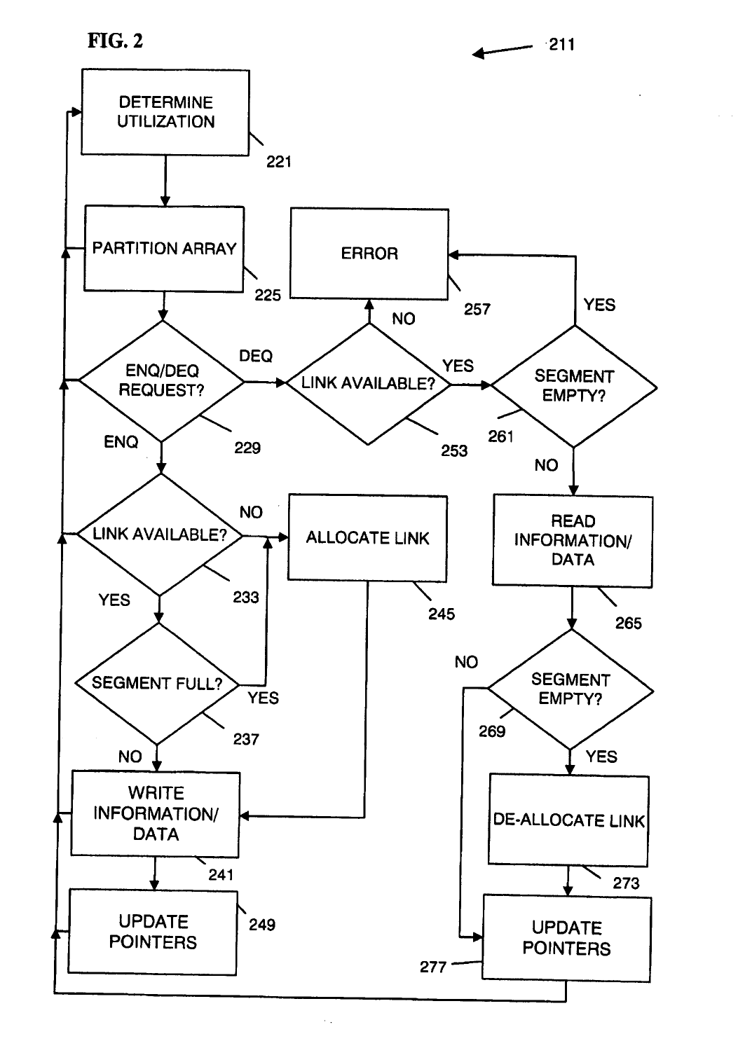

FIG. 2 is a flow chart illustrating several methods according to various embodiments. A method 211 may (optionally) begin with determining hardware utilization at block 221, such as a maximum hardware utilization comprising a number of shareable bits divided by the sum of a total number of information bits and a total number of link bits. The result may provide guidance with respect to the activity of block 225, wherein the method 211 may continue with partitioning an information array into two or more segments, each of which may have the same number of memory locations, or a different number of memory locations. Memory segments may be included in any type of storage area, such as a transmit queue storage, or a receive queue storage.

At block 229, the method 211 may include determining whether information is to be enqueued or dequeued. If information is to be enqueued, then the method 211 may continue with determining whether a link is available at block 233. If a link is available, then a determination may be made as to whether the linked segment is full at block 237. If the segment is not full, then the method may continue with writing the information to the segment at block 241.

The segment may be operated as a first-in, first-out (FIFO) resource with respect to the linked port. For example, such operation might include writing a first datum to be enqueued to the port to a first memory location included in the memory segment, and perhaps after determining the existence of the link, writing a second datum to be enqueued to the port to a successive (second) memory location included in the memory segment. After the information is written at block 241, various pointers such as write pointers and perhaps an EMPTY flag for the segment, may be updated at block 249.

If no link is determined to exist at block 233, then the method 211 may include allocating a link from a plurality of memory locations (included in a segment of a memory) to the selected port at substantially the same time at block 245. The method may continue with writing the information to newly-allocated segment at block 241. The method 211 may include allocating additional links from other segments to a selected port, or to another port, when it is determined that all of the memory locations in an allocated segment are occupied by information. For example, the method 211 may include allocating a second link from a plurality of memory locations included in a second memory segment of a memory to the selected port at substantially the same time.

If information is to be dequeued, as determined at block 229, then the method 211 may continue with determining whether a link has been allocated at block 253. If no link has been allocated, an error condition may result at block 257. If a link has been allocated, then the method 211 may continue with determining whether the associated segment is empty at block 261. If the segment is empty, then an error condition may result at block 257. If the segment is not empty, as determined at block 261, then the information requested may be read at block 265. If reading the information results in an empty segment, as determined at block 269, then the segment may be de-allocated (i.e., returned to the pool of available segments) at block 273, and various pointers, such as read pointers and other indicators (e.g. the EMPTY flag) may be updated at block 277. However, if the segment is not empty after the read operation, as determined at block 269, then the method 211 may continue with updating pointers at block 277.

As noted previously, the method 211 may include operating the memory segments as FIFO resources. For example, the method 211 may include reading a first datum to be dequeued from the port from a first memory location included in the memory segment, reading a second datum to be dequeued from the port from a successive (second) memory location included in the memory segment, and (if the segment is empty) de-allocating the link. In addition, the method 211 may include determining that none of the plurality of memory locations in a memory segment are occupied by information, and de-allocating the link between that segment and a selected port.

It should be noted that the methods described herein do not have to be executed in the order described, or in any particular order. Moreover, various activities described with respect to the methods identified herein can be executed in serial or parallel fashion. For the purposes of this document, the terms “information” and “data” may be used interchangeably. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well-known to those skilled in the art, such as application program interfaces or interprocess communication techniques, including remote procedure calls. The teachings of various embodiments are not limited to any particular programming language or environment, including Hypertext Markup Language (HTML) and Extensible Markup Language (XML).

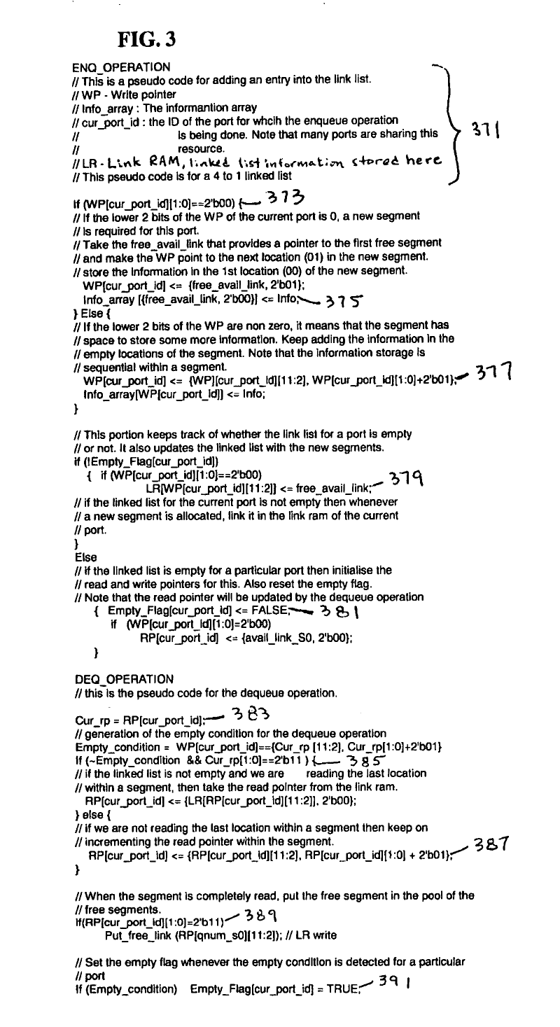

Thus, other embodiments may be realized. FIG. 3 is a pseudocode listing that illustrates several methods of supporting enqueue and dequeue operations according to various embodiments. In the initial section 371, several variables are initialized to set up an enqueue operation. These include the write pointer (WP), the information array (Info_array), and the identification of the port selected for linking (cur_port_id), as well as the link-list information (LR).

At line 373, a determination is made as to whether there is space available using a previously-allocated link. Thus, assuming a 4:1 LL linked-list, if the lower two bits of the write pointer for the selected port is zero, a new segment can be linked to the port. The pointer to the first free segment, free_avail_link, is used to update the write pointer so as to point to the next available location in the new segment. The information is then stored in the first location at line 375.

At line 377, it has been determined that the lower 2 bits of the write pointer are not zero, meaning that the currently allocated segment includes space available to store more information. Thus, new information will be added to the same segment, in an empty location. Information storage may be sequential within a segment.

At line 379, the linked-list is updated with new segments. If the linked-list for the selected port is not empty, then whenever a new segment is allocated, it is linked to the existing linked list of the current port). Otherwise, at line 381, if it is determined that the linked-list is empty for the selected port, the read/write pointers can be initialized to allocate the first segment to the selected port, and the EMPTY flag can be reset. The read pointer may be updated during a dequeue operation.

Line 383 begins the pseudocode for the dequeue operation, where information is removed from the port queue. As was the case for the enqueue operation, certain variables can be initialized, such as the read pointer (Cur_rp).

At line 385, a determination is made as to whether the linked list is empty or not If it is not empty, and the read operation is from the last location in the segment, then the next read pointer may be obtained from the link ram, i.e., the link to the next segment can be obtained. However, if the read operation is not from the last location in the segment, then the read pointer within that segment may be incremented at line 387. When it is determined that the segment has been completely read at line 389, the segment can be released to a pool of free segments, where it can be allocated to the same port, or another port, as needed. If the segment is determined to be empty at line 391, then the EMPTY flag can be set.

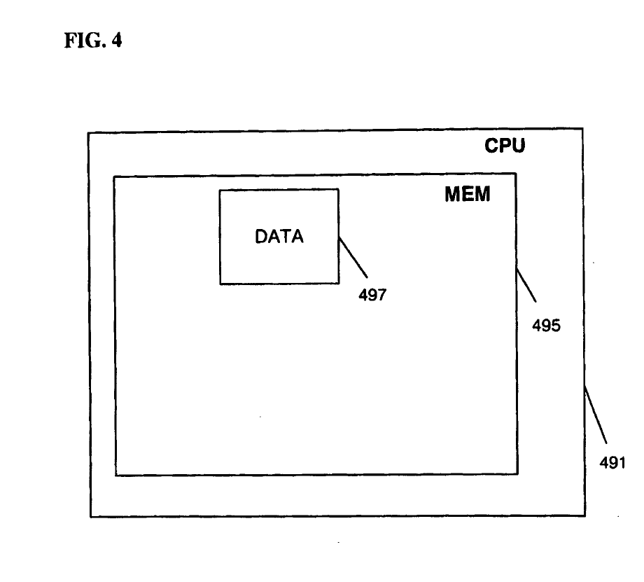

Still further embodiments may be realized. For example, FIG. 4 is a block diagram of an article 491 according to various embodiments, such as a computer, a memory system, a magnetic or optical disk, some other storage device, and/or any type of electronic device or system. The article 491 may comprise a machine-accessible medium such as a memory 495 (e.g., a memory including an electrical, optical, or electromagnetic conductor) having associated data 497 (e.g., computer program instructions), which when accessed, results in a machine performing such actions as allocating a link from a plurality of memory locations (perhaps included in a memory segment of a memory) to a port at substantially the same time. As noted previously, each of the plurality of memory locations in a segment may include a plurality of bits.

Other activities may include choosing a number of the plurality of memory locations included in the memory segment by determining a maximum hardware utilization, perhaps comprising a number of shareable bits divided by a sum of a total number of information bits and a total number of link bits. Further activities may include determining that all of the plurality of memory locations are occupied by data, and allocating a second link from a plurality of memory locations included in a second memory segment of the memory to the port at substantially the same time. The second link may also be allocated to another port, if desired.

Other activities may include determining that none of the plurality of memory locations in the second memory segment are occupied by second data; and de-allocating the second link (assuming that the second link has already been allocated to the selected port). The second link may then be allocated to another port, or re-allocated to the same port, as desired.

The number of memory locations included in each memory segment may be the same or different. Memory segments may comprise any type of storage, including transmit queue storage or receive queue storage.

Reduced hardware requirements with respect to managing links from information arrays to ports may result by using the apparatus, methods, and systems disclosed herein. Improved performance may result when the width of information (in bits) is less than or comparable to the log₂(information array depth).

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method, comprising:
allocating a link from a plurality of memory locations included in a memory segment of a memory to a port at substantially a first time, wherein each of the plurality of memory locations includes a plurality of bits.

2. The method of claim 1, further comprising:
partitioning an information array into at least two segments including the memory segment.

3. The method of claim 1, further comprising:
operating the memory segment as a first-in, first-out resource with respect to the port.

4. The method of claim 3, wherein operating the memory segment as a first-in, first-out resource further comprises:
writing a first datum to be enqueued to the port to a first memory location included in the memory segment;
determining an existence of the link; and
writing a second datum to be enqueued to the port to a second memory location included in the memory segment.

5. The method of claim 3, wherein operating the memory segment as a first-in, first-out resource further comprises:
reading a first datum to be enqueued to the port from a first memory location included in the memory segment;
reading a second datum to be enqueued to the port from a second memory location included in the memory segment; and
de-allocating the link.

6. The method of claim 1, further comprising:
allocating a second link from a plurality of memory locations included in a second memory segment of the memory to the port at substantially a second time, wherein each of the plurality of memory locations included in the second memory segment includes a plurality of bits.

7. The method of claim 1, further comprising:
determining a maximum hardware utilization as a number of shareable bits divided by a sum of a total number of information bits and a total number of link bits.

8. An article comprising a machine-accessible medium having associated first data, wherein the first data, when accessed, results in a machine performing:
allocating a link from a first plurality of memory locations included in a first memory segment of a memory to a port at substantially a first time, wherein each of the first plurality of memory locations includes a plurality of bits.

9. The article of claim 8, wherein the first data, when accessed, results in the machine performing:
choosing a number of the first plurality of memory locations by determining a maximum hardware utilization as a number of shareable bits divided by a sum of a total number of information bits and a total number of link bits.

10. The article of claim 8, wherein the first data, when accessed, results in the machine performing:
determining that all of the first plurality of memory locations are occupied by second data; and
allocating a second link from a second plurality of memory locations included in a second memory segment of the memory to the port at substantially a second time, wherein each of the second plurality of memory locations includes a plurality of bits.

11. The article of claim 10, wherein the first data, when accessed, results in the machine performing:
determining that none of the second plurality of memory locations are occupied by second data; and
de-allocating the second link.

12. The article of claim 11, wherein the first data, when accessed, results in the machine performing:
allocating the second link to another port.

13. The article of claim 10, wherein the number of the second plurality of memory locations is the same as the number of the first plurality of memory locations.

14. The article of claim 8, wherein the memory segment is included in a transmit queue storage.

15. An apparatus, comprising:
a port; and
a module to allocate a link from a plurality of memory locations included in a memory segment to the port at substantially one time, wherein each of the plurality of memory locations includes a plurality of bits.

16. The apparatus of claim 15, further comprising:
a memory comprising a plurality of memory segments including the memory segment.

17. The apparatus of claim 16, wherein a number of memory locations in each one of the plurality of memory segments is equal to a number of the plurality of memory locations.

18. The apparatus of claim 15, wherein a number of the plurality of memory locations included in the memory segment is chosen in accordance with a maximum hardware utilization substantially equal to a number of shareable bits divided by a sum of a total number of information bits and a total number of link bits.

19. The apparatus of claim 15, wherein a number of the plurality of bits is equal to an information array width, and wherein the information array width is about equal to or less than the value of log₂ of an information array depth.

20. A system, comprising:
a first port and a second port;
a memory coupled to the first port and to the second port; and
a module to allocate a first link from a plurality of memory locations included in a first memory segment included in the memory to the first port at substantially a first time, and to allocate a second link from a plurality of memory locations included in a second memory segment included in the memory to the second port at substantially a second time, wherein each of the plurality of memory locations included in the first memory segment and the second memory segment includes a plurality of bits.

21. The system of claim 20, further comprising:
an omnidirectional antenna to receive information to be stored in the memory.

22. The system of claim 20, wherein the memory is to store the first link and the second link.

23. The system of claim 20, further comprising:
a communications medium to couple the first port to a data switch.
